(19) United States
(12) Patent Application Publication
(10) Pub. No.: US 2019/0055434 A1
(43) Pub. Date: Feb. 21, 2019

(54) POLYPHENYLENE OXIDE-GRAFTED ACRYLIC ADHESIVE

(71) Applicant: 3M INNOVATIVE PROPERTIES COMPANY, St. Paul, MN (US)

(72) Inventors: Joon Chatterjee, Gaithersburg, MD (US); Jenny B. Werness, St. Paul, MN (US); Stefan H. Gryska, Woodbury, MN (US); Babu N. Gaddam, Woodbury, MN (US); Surojit Sinha, Bangalore (IN); Raja Krishnamurthy, Bangalore (IN)

(21) Appl. No.: 16/077,881

(22) PCT Filed: Apr. 12, 2017
(86) PCT No.: PCT/US2017/027090

§ 371 Date: Aug. 14, 2018

Related U.S. Application Data
(60) Provisional application No. 62/324,364, filed on Apr. 19, 2016.

(51) Int. Cl. C09J 7/38; C08L 51/08

(52) U.S. Cl. CPC C09J 7/385; C08L 51/08

(57) ABSTRACT

An adhesive copolymer comprising acrylate ester monomer units, poly(phenyleneoxide)-functional (meth)acryloyl monomer units, optional acid-functional monomer units, and optional non-acid functional polar monomer units is described.

### FIELD OF THE INVENTION

The present invention relates to adhesives, more specifically to pressure sensitive adhesives. In particular, the invention relates to pressure sensitive adhesives having favorable shear properties at elevated temperatures.

### BACKGROUND

Pressure-sensitive tapes are virtually ubiquitous in the home and workplace. In its simplest configuration, a pressure-sensitive tape comprises an adhesive and a backing, and the overall construction is tacky at the use temperature and adheres to a variety of substrates using only moderate pressure to form the bond. In this fashion, pressure-sensitive tapes constitute a complete, self-contained bonding system.

According to the Pressure-Sensitive Tape Council, pressure-sensitive adhesives (PSAs) are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). PSAs do not embrace compositions merely because they are sticky or adhere to a surface.

These requirements are assessed generally by means of tests which are designed to individually measure tack, adhesion (peel strength), and cohesion (shear holding power), as noted in A. V. Pocius in Adhesion and Adhesives Technology: An Introduction, 2^{nd} Ed., Hanser Gardner Publication, Cincinnati, Ohio, 2002. These measurements taken together constitute the balance of properties often used to characterize a PSA.

Pressure sensitive adhesive (PSA) compositions are used in a wide variety of applications, including many assembly and manufacturing applications. Numerous applications require PSAs to support a load at elevated temperatures, typically in the range of greater than 70° C., for which high cohesive strength PSAs are required. A standard method of increasing cohesive strength at elevated temperatures is to chemically crosslink the PSA using irradiation processes, such as thermal radiation, ultraviolet (UV) radiation, gamma radiation, and electron beam (EB) radiation, etc. Although these processes improve cohesive strength, they often negatively impact other properties, including peel strength of the PSA.

### SUMMARY

A need exists for an improved PSA with high cohesive strength that does not require chemical crosslinking. The adhesive compositions of the invention generally demonstrate desirable cohesive strength at elevated temperatures. This cohesive strength can be at least as high as that obtained with chemical crosslinking. Thus, the adhesive composition provides many of the advantages of crosslinking without various disadvantages, such as excessive degradation of the adhesive and loss of adhesion.

The present disclosure provides new pressure sensitive adhesive (PSA) compositions comprised of acrylic polymers grafted with polyphenylene oxide (PPO). The present disclosure further provides adhesive articles having a layer of the adhesive.

The pressure-sensitive adhesives of this disclosure provide the desired balance of tack, peel adhesion, and shear holding power, and further conform to the Dahlquist criteria; i.e. the modulus of the adhesive at the application temperature, typically room temperature, is less than 3×10⁵ Pascal at a frequency of 1 Hz. The PPO-grafted polymers significantly increase the shear holding properties, particularly the high temperature shear properties of the adhesive.

The instant adhesive copolymers enable a simplified manufacturing process as the composition uses physical crosslinking derived from the PPO grafts. Since there is no chemical crosslinking or crosslinking agents required it does not require manufacturing steps like thermal curing chambers, or radiation processes of ultraviolet or electron beam radiation.

### DETAILED DESCRIPTION

The adhesive copolymer comprises acrylate ester monomer units, PPO-functional (meth)acryloyl monomer units, optional acid-functional monomer units, and optional non-acid functional polar monomer units. The copolymer is of the formula:

˜[M^{Ester}]ₐ-[M^{PPO}]_{b}-[M^{acid}]_{c}-[M^{polar}]_{d}˜, I

wherein
[M^{Ester}] represents (meth)acrylate monomer units of subscript a parts by weight;
[M^{PPO}] represents oligomeric PPO functional monomer units of subscript b parts by weight;
[M^{acid}] represents acid functional monomer units of subscript c parts by weight;
[M^{polar}] represents non-acid-functional polar monomer units of subscript d parts by weight.

The (meth)acrylate ester monomer useful in preparing the functional (meth)acrylate adhesive copolymer is a monomeric (meth)acrylic ester of a non-tertiary alcohol, which alcohol contains from 1 to 14 carbon atoms and preferably an average of from 4 to 12 carbon atoms.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof, although combinations of two or more different (meth)acrylate ester monomer are suitable. In some embodiments, the preferred (meth)acrylate ester monomer is the ester of (meth)acrylic acid with an alcohol derived from a renewable source, such as 2-octanol, citronellol, dihydrocitronellol.

In some embodiments it is desirable for the (meth)acrylic acid ester monomer to include a high T_{g} monomer, having a T_{g} of at least 25° C., and preferably at least 50° C. Suitable high T_{g} monomers include Examples of suitable monomers useful in the present invention include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The (meth)acrylate ester monomer is present in an amount of 80 to 99.9 parts by weight based on 100 parts total monomer content used to prepare the polymer. Preferably (meth)acrylate ester monomer is present in an amount of 80 to 95 parts by weight based on 100 parts total monomer content. When high T_{g} monomers are included, the copolymer may include up to 30 parts by weight, preferably up to 20 parts by weight of the 80 to 99.5 parts by weight of (meth)acrylate ester monomer component.

The M^{PPO} monomer units may be derived from a monomer of the formula:

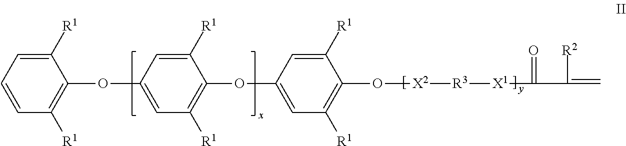

wherein
R¹ is H, a monovalent hydrocarbyl group, including alkyl and aryl, and is preferably C₁-C₄ alkyl;
R² is H or C₁-C₄ alkyl,
R³ is a divalent alkylene;
X¹ is —O— or —NR⁴—, where R⁴ is H or C₁-C₄ alkyl;
X² is —CO—NH—, —CO— CH₂—CH(OH)—CH₂—, or a covalent bond;
subscript x is at least one, preferably 10-100, more preferably 20-60; and
subscript y is 0 or 1.

The PPO functional monomer may be prepared by an addition, condensation or displacement reaction between PPO oligomer and a (meth)acryloyl compound, such as a (meth)acrylate ester or a (meth)acryloyl halide. Alternatively, the monomer may be prepared by reaction of a PPO oligomer with a functional (meth)acryloyl compound, the functional group of which is reactive with the hydroxyl group of the PPO oligomer, as illustrated below.

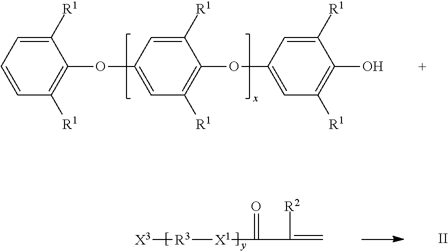

wherein
R¹ is H, a monovalent hydrocarbyl group, including alkyl and aryl, and is preferably C₁-C₄ alkyl;
R² is H or C₁-C₄ alkyl,
R³ is a divalent alkylene;
X¹ is —O— or —NR⁴—, where R⁴ is H or C₁-C₄ alkyl;
X² is —CO—NH—, —CO— CH₂—CH(OH)—CH₂—, or a covalent bond;
X³ is any functional group that is reactive with the hydroxyl group of the PPO oligomer; subscript x is at least one, preferably 10-100, more preferably 20-60; and
subscript y is 0 or 1.

In the reaction scheme, X³ may be any functional group that is reactive with the hydroxyl group of the PPO oligomer, including carboxyl, isocyanato, epoxy, anhydride, acyl halide, or oxazolinyl group. X³ can be a leaving groups such as halide or tosylate. Useful acryloyl monomers having hydroxy-reactive functional groups include isocyanatoalkyl (meth)acrylates and (meth)acrylamides such as isocyanatoethyl (meth)acrylate and 4-isocyanatocyclohexyl (meth)acrylate, epoxy-functional alkyl (meth)acrylates and (meth)acrylamides, aziridine-functional alkyl (meth)acrylates and (meth)acrylamide; epoxy-substituted compounds such as glycidyl (meth)acrylate; and aziridinyl-substituted compounds such as N-(meth)acryloylaziridine.

Useful polyphenylene oxide resins used in preparing the copolymers have a glass transition temperatures (T_{g}) between about 110 to 210° C. preferably 140 to 170° C., more preferably 140 to 165° C., as determined by differential scanning calorimetry and a weight average molecular weight (M_{w}) ranging from about 1,000 to about 25,000 Da, preferably 2,000 to 10,000 Da, more preferably 4,000 to 8,000 Da.

Polyphenylene oxide resin can be prepared as described in U.S. Pat. No. 3,306,874 (Hay); U.S. Pat. No. 3,306,875 (Hay); U.S. Pat. No. 3,257,357 (Stamatoff); and U.S. Pat. No. 3,257,358 (Stamatoff). Useful commercially available PPO resins include SA 120™ PPO resin oligomer from SABIC, Pittsfield, Mass.

The PPO-functional monomer units are present in the copolymer in 0.1-10, preferably 0.1-5 parts by weight, based on a total of 100 parts by weight of the copolymer. With reference to the copolymer of Formula I, subscript b reflects these amounts, so b may be zero or non-zero, or a normalized, non-integral value.

The copolymer may comprise an acid functional monomer designated M^{acid}, where the acid functional group may be an acid per se, such as a carboxylic acid, or a portion may be a salt thereof, such as an alkali metal carboxylate.

Useful acid functional monomers include, but are not limited to, those selected from ethylenically unsaturated carboxylic acids, ethylenically unsaturated sulfonic acids, ethylenically unsaturated phosphonic or phosphoric acids, and mixtures thereof. Examples of such compounds include those selected from acrylic acid, methacrylic acid, itaconic acid, fumaric acid, crotonic acid, citraconic acid, maleic acid, oleic acid, b-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids.

The acid-functional monomer may be present in amounts of 0 to 15 parts by weight, preferably 0.5 to 5 parts by weight, based on 100 parts by weight total monomer. With reference to the copolymer of Formula I, subscript c reflects these amounts, so c may be zero or non-zero, or a normalized, non-integral value.

The copolymer may further comprise a polar monomer designated M^{polar} in Formula I. The polar monomers useful in preparing the copolymer are both somewhat oil soluble and water soluble, resulting in a distribution of the polar monomer between the aqueous and oil phases in an emulsion polymerization. As used herein the term “polar monomers” are inclusive of acid functional monomers.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamides, such as t-butyl acrylamide, dimethylaminoethyl acrylamide or N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl (meth)acrylate; polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

The polar monomer may be present in amounts of 0 to 10 parts by weight, preferably 0.5 to 5 parts by weight, based on 100 parts by weight total monomer. With reference to the copolymer of Formula I, subscript d reflects these amounts, so d may be zero or non-zero, or a normalized, non-integral value.

The adhesive copolymer of Formula I may be prepared by free radical copolymerization of the PPO-functional monomer of Formula II with the other monomers. The copolymer of Formula I can be prepared by techniques including, but not limited to, the conventional techniques of solvent polymerization, dispersion polymerization, and solventless bulk polymerization. The initiator may be a thermal or photoinitiator.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature until the reaction is completed. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

Initiators useful in preparing the copolymer stabilizer used in the present invention are initiators that, on exposure to heat or light, generate free-radicals which initiate (co)polymerization of the monomer mixture. The curable composition may further comprise thermal or photoinitiators, in an amount between the range of about 0.1% and about 5% by weight.

Useful photoinitiators include those known as useful for photocuring free-radically (meth)acrylates. Exemplary photoinitiators include benzoin and its derivatives such as alpha-methylbenzoin; alpha-phenylbenzoin; alpha-allylbenzoin; alpha-benzylbenzoin; benzoin ethers such as benzil dimethyl ketal (e.g., “IRGACURE 651” from BASF, Florham Park, N.J.), benzoin methyl ether, benzoin ethyl ether, benzoin n-butyl ether; acetophenone and its derivatives such as 2-hydroxy-2-methyl-1-phenyl-1-propanone (e.g., “DAROCUR 1173” from BASF, Florham Park, N.J.) and 1-hydroxycyclohexyl phenyl ketone (e.g., “IRGACURE 184” from BASF, Florham Park, N.J.); 2-methyl-1-[4-(methylthio)phenyl]-2-(4-morpholinyl)-1-propanone (e.g., “IRGACURE 907” from BASF, Florham Park, N.J.); 2-benzyl-2-(dimethylamino)-1-[4-(4-morpholinyl)phenyl]-1-butanone (e.g., “IRGACURE 369” from BASF, Florham Park, N.J.) and phosphine oxide derivatives such as ethyl-2,4,6-trimethylbenzoylphenylphoshinate (e.g. “TPO-L” from BASF, Florham Park, N.J.), and IRGACURE 819 (phenylbis(2,4,6-trimethylbenzoyl)phosphine oxide) available from BASF, Florham Park, N.J.

Other useful photoinitiators include, for example, pivaloin ethyl ether, anisoin ethyl ether, anthraquinones (e.g., anthraquinone, 2-ethylanthraquinone, 1-chloroanthraquinone, 1,4-dimethylanthraquinone, 1-methoxyanthraquinone, or benzanthraquinone), halomethyltriazines, benzophenone and its derivatives, iodonium salts and sulfonium salts, titanium complexes such as bis(eta₅-2,4-cyclopentadien-1-yl)-bis[2,6-difluoro-3-(1H-pyrrol-1-yl) phenyl]titanium (e.g., “CGI 784DC” from BASF, Florham Park, N.J.); halomethyl-nitrobenzenes (e.g., 4-bromomethylnitrobenzene), mono- and bis-acylphosphines (e.g., “IRGACURE 1700”, “IRGACURE 1800”, “IRGACURE 1850”, and “DAROCUR 4265”).

The curable composition may be irradiated with activating UV or visible radiation to polymerize the components preferably in the wavelengths of 250 to 500 nanometers. UV light sources can be of two types: 1) relatively low light intensity sources such as blacklights that provide generally 10 mW/cm² or less (as measured in accordance with procedures approved by the United States National Institute of Standards and Technology as, for example, with a UVIMAP™ UM 365 L-S radiometer manufactured by Electronic Instrumentation & Technology, Inc., in Sterling, Va.) over a wavelength range of 280 to 400 nanometers and 2) relatively high light intensity sources such as medium- and high-pressure mercury arc lamps, electrodeless mercury lamps, light emitting diodes, mercury-xenon lamps, lasers and the like, which provide intensities generally between 10 and 5000 mW/cm² in the wavelength rages of 320-390 nm (as measured in accordance with procedures approved by the United States National Institute of Standards and Technology as, for example, with a PowerPuck™ radiometer manufactured by Electronic Instrumentation & Technology, Inc., in Sterling, Va.).

Suitable thermal initiators include but are not limited to those selected from the group consisting of azo compounds such as VAZO™ 64 (2,2′-azobis(isobutyronitrile)) and VAZO™ 52 (2,2′-azobis(2,4-dimethylpentanenitrile)), both available from E.I. du Pont de Nemours Co., peroxides such as benzoyl peroxide and lauroyl peroxide, and mixtures thereof. The preferred thermal initiator is (2,2′-azobis(isobutyronitrile)). When used, initiators may comprise from about 0.05 to about 1 part by weight, preferably about 0.1 to about 0.5 part by weight based on 100 parts by weight of monomer components in the pressure-sensitive adhesive.

If desired, the molecular weight, M_{w}, of the copolymer of Formula I may be controlled with the use of chain transfer agents. Examples of useful chain transfer agents include but are not limited to those selected from the group consisting of carbon tetrabromide, alcohols, mercaptans, and mixtures thereof. When present, the preferred chain transfer agents are isooctylthioglycolate and carbon tetrabromide. The emulsion mixture may further comprise up to about 0.5 parts by weight of a chain transfer agent, typically about 0.01 to about 0.5 parts by weight, if used, preferably about 0.05 parts by weight to about 0.2 parts by weight, based upon 100 parts by weight of the total monomer mixture.

Instead of using the monomer of Formula II, the copolymer may be provided with the PPO monomer units by an indirect method whereby the copolymer is provided with monomer units having a hydroxy reactive functional group (“FG”) and the resulting copolymer is subsequently functionalized with the PPO group. For example, the copolymer may be prepared using an isocyanate-substituted monomer such as isocyanatoethyl acrylate to provide a copolymer having pendent isocyanate groups. This copolymer may then be reacted with the PPO oligomer to produce the PPO-functionalized copolymer of Formula I. In this embodiment, a copolymer having a pendent functional group (reactive toward the hydroxyl group of the PPO oligomer), is prepared and subsequently functionalized with the PPO oligomer:

˜[M^{Ester}]ₐ-[M^{FG}]_{b}-[M^{acid}]_{c}-[M^{polar}]_{d}˜, III

wherein
[M^{Ester}] represents (meth)acrylate monomer units of subscript a parts by weight;
[M^{FG}] represents PPO-reactive functional monomer units of subscript b* parts by weight;
[M^{acid}] represents acid functional monomer units of subscript c parts by weight;
[M^{polar}] represents non-acid-functional polar monomer units of subscript d parts by weight.

With reference to the preparation of PPO-functional monomer supra, the copolymer may be prepared with monomer units having pendent functional groups “FG”, then subsequently functionalized with the PPO oligomer. Copolymer III may be converted to Copolymer I. The FG groups correspond to the “X³” functional groups supra. The copolymer may be prepared using a monomer having a functional group FG, that is reactive with the hydroxyl groups of the PPO oligomer.

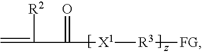

where
R² is H or C₁-C₄ alkyl,
R³ is a divalent alkylene;
X¹ is —O— or —NR⁴—, where R⁴ is H or C₁-C₄ alkyl; and
subscript z is 0 or 1.

When copolymerized with the other monomers, it yields a copolymer having a pendent reactive functional groups FG, which may be functionalized with the PPO oligomer;

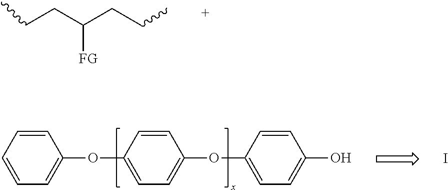

Physical crosslinking typically relies on the natural or induced formation of entanglements within the grafted polymeric chains and tends to increase the cohesive strength of adhesive compositions such as pressure-sensitive adhesive compositions. Physical crosslinking is often desired because the pressure-sensitive adhesive can be processed in a melted state at relatively high temperatures yet can take on a crosslinked form at lower temperatures. That is, the pressure-sensitive adhesives can be used as hot melt adhesives. In contrast, chemical crosslinked pressure-sensitive adhesives typically cannot be processed as hot melt adhesives. Hot melt processing is often considered desirable because the use of inert organic solvents can be minimized or eliminated. The minimization or elimination of inert organic solvents can be desirable from both an environmental and economic perspective.

By avoiding chemical crosslinking the tackiness and adhesion characteristics of the adhesive composition are more easily preserved. This absence of chemical crosslinks can be demonstrated, for example, by the gel content of the adhesive composition. In most implementations the polymeric mixture has a gel content of less than 25 percent of the crosslinkable material, preferably less than 10 percent and more preferably less than 2 percent. The gel content can be estimated by determining the fraction of a composition that becomes insoluble through crosslinking. Generally chemical crosslinks are not soluble and physical crosslinks are soluble when appropriate solvents are employed.

It is desirable for the adhesive composition to be substantially solvent-free. That is, it is preferred that the adhesive composition contain less than 20 wt. % solvent, more preferably, contain substantially less than about 10 wt. % solvent and, even more preferably, contain less than about 5 wt. % solvent.

The molecular weight of the PPO grafted group can affect whether or not the grafted copolymer of Formula I will phase separate and physically crosslink. Phase separation and entanglement is more likely if number of repeat units of a given grafted group is at least 10. If the number if too low then there will not be phase separation of the PPO segments, and therefore no benefits of increased cohesive strength.

It will be appreciated that the polymerization is essentially uncontrolled, and a range of repeat units (subscript x of Formula I) will be present. However, the pendent PPO group of Formulas I or II are prepared with a sufficient number of grafted PPO monomer repeat units such that the PPO groups will phase separate to effect physical crosslinking. Generally, the PPO group of the copolymer will have at least three phenylene oxide repeat units (x=0 in Formulas I and II) and will preferably have at least 12 repeat units (x=10).

If the molecular weight of the grafted PPO groups becomes too large (i.e. the number of repeat units b is too large), the number of grafted PPO polymer groups formed on a weight basis by reaction with the main polymer chain may be diminished. That is, as the molecular weight of the grafted PPO groups increases, it can become more difficult to achieve a high degree of substitution of grafted high PPO groups on a weight basis.

A tackifier resin may be added as a component to the adhesive composition of the present invention and shall mean a material which is miscible with the copolymer and has a number average molecular weight (Mₙ) of 10,000 Da or less and a glass transition temperature (Tg) of −30° C. or more as measured by differential scanning calorimetry.

Tackifiers useful in the present invention include rosin and rosin derivatives, hydrocarbon tackifier resins, aromatic hydrocarbon resins, aliphatic hydrocarbon resins, terpene resins, etc. Commercially available examples include alpha-pinene resins, available from Hercules Inc., Wilmington, Del. under the trade designation PICCOLYTE A135 or PICCOLYTE A115 available from Arizona Chemical Division, International Paper, Panama City, Fla. under the trade designation “Zonarez A25”; beta-pinene resins, available from Hercules Inc., Wilmington, Del. under the trade designation “Piccolyte S135” or “Piccolyte S115”; or petroleum derived hydrocarbon resin, available from Goodyear Tire & Rubber Co., Chemical Div, Akron Ohio under the trade designation “Wingtack Plus”.

Typically, the tackifier resin is present in the adhesive composition in amounts ranging from about 1 to about 80 weight %, preferably 5 to 50 weight %, based on the total weight % of the adhesive composition.

The adhesive composition may also include additives such as fillers, stabilizers, antioxidants, and pigments for the conventional purpose of these additives. The above-described compositions are coated on a substrate or backing using conventional coating techniques modified as appropriate to the particular substrate. For example, these compositions can be applied to a variety of solid substrates by methods such as roller coating, flow coating, dip coating, spin coating, spray coating, knife coating, and die coating. These various methods of coating allow the compositions to be placed on the substrate at variable thicknesses thus allowing a wider range of use of the compositions. Coating thicknesses may vary, but coating thicknesses of 2-500 micrometers (dry thickness), preferably about 10 to 250 micrometers, are contemplated.

The substrate is selected depending on the particular application in which it is to be used. For example, the adhesive can be applied to sheeting products, (e.g., decorative graphics and reflective products), label stock, and tape backings.

Examples of materials that can be included in the backings include polyolefins such as polyethylene, polypropylene (including isotactic polypropylene), polystyrene, polyester, polyvinyl alcohol, poly(ethylene terephthalate), poly(butylene terephthalate), poly(caprolactam), poly(vinylidene fluoride), polylactides, cellulose acetate, and ethyl cellulose and the like. Commercially available backing materials useful in the invention include kraft paper (available from Monadnock Paper, Inc.); cellophane (available from Flexel Corp.); spun-bond poly(ethylene) and poly(propylene), such as Tyvek™ and Typar™ (available from DuPont, Inc.); and porous films obtained from poly(ethylene) and poly(propylene), such as Teslin™ (available from PPG Industries, Inc.), and Cellguard™ (available from Hoechst-Celanese).

Backings may also be prepared of fabric such as woven fabric formed of threads of synthetic or natural materials such as cotton, nylon, rayon, glass, ceramic materials, and the like or nonwoven fabric such as air laid webs of natural or synthetic fibers or blends of these. The backing may also be formed of metal, metallized polymer films, or ceramic sheet materials and may take the form of any article conventionally known to be utilized with pressure sensitive adhesive compositions such as labels, tapes, signs, covers, marking indicia, and the like.

The substrate may also comprise a release-coated substrate. Such substrates are typically employed when an adhesive transfer tape is provided. Examples of release-coated substrates are well known in the art and include, by way of example, silicone-coated kraft paper and the like. Tapes of the invention may also incorporate a low adhesion backsize (LAB) which are known in the art.

The adhesive can also be provided in the form of an adhesive transfer tape in which at least one layer of the adhesive is disposed on a release liner for application to a permanent substrate at a later time. The adhesive can also be provided as a single coated or double coated tape in which the adhesive is disposed on a permanent backing.

### Materials

| Designation | Description |
|---|---|
| SA120 | A low molecular weight polymer based on polyphenylene |
| | ether (PPE) (also referred to as polyphenylene oxide |
| | (PPO)), having a glass transition temperature of 165° |
| | C., a softening point (ring and ball) of 210° C., a |
| | weight average molecular weight of 6300 grams/mole |
| | and a number average molecular weight of 2350 |
| | grams/mole (both by gel permeation chromatography |
| | (GPC)), a phenolic end group content of 425 moles/gram, |
| | available under the trade designation NORYL RESIN |
| | SA120, from Saudi Basic Industries (SABIC), |
| | Pittsfield, MA. |
| IOA | Isooctyl acrylate, obtained from 3M Company, St. |
| | Paul, MN. |
| AA | Acrylic acid, available from BASF Corporation, |
| | Florham Park, NJ. |
| VAZO 67 | (2,2′-azobis-(2-methylbutyronitrile)), a thermally activated |
| | free radical initiator, available under the trade designation |
| | VAZO 67, from Chemours Company, Wilmington, DE. |
| I651 | 2,2-dimethoxy-1,2-diphenyl ethan-1-one, a light (UV) light |
| | activated free radical initiator, available under trade |
| | designation of IRGACURE 651, BASF Corporation |
| | Florham Park, NJ. |
| FORAL | A tackifier resin based on a thermoplastic ester resin |
| 85E | derived from glycerol and a highly stabilized rosin, with |
| | a softening point of between 80 and 88° C. (Hercules |
| | Drop Method), available under the trade designation |
| | FORAL 85-E ESTER OF HYDROGENATED ROSIN, |
| | from Eastman Chemical Company Kingsport, TN. |
| PET Film | A polyethylene terephthalate (polyester, PET) film |
| | chemically treated (primed) on one side, having |
| | thickness of 51 micrometers (0.002 inches), available under |
| | the trade designation HOSTAPHAN 3SAB, available from |
| | Mitsubishi Polyester Film, Incorporated, Greer, SC. |

### Test Methods

### Peel Adhesion Strength (180° Angle)

Peel adhesion strength was measured according to ASTM D3330/D3330M-04: “Standard Test Method for Peel Adhesion of Pressure Sensitive Tape” (Reapproved 2010). After conditioning for 24 hours at 23° C. (73° F.) and 50% relative humidity (RH), tape samples measuring 12.7 millimeters (0.5 inches) wide and 20.3 centimeters (8 inches) long were cut. The tape samples were then applied to a glass plate previously wiped clean with methyl ethyl ketone (MEK), then n-heptane, and again with MEK. The tape was rolled down twice in each direction using a 2 kilogram (4.4 pounds) rubber roller. After a 30 minute dwell time peel adhesion strength was then measured, under the same temperature and relative humidity as used above, at an angle of 180 degrees, a rate of 305 millimeters/minute (12 inches/minute), and a length of 5.1 centimeters (2 inches) using a peel adhesion tester (IMASS Slip/Peel Tester, Model SP-2000, available from IMASS Incorporated, Accord, Mass.). Three samples were evaluated, the results normalized to ounces/inch (oz/in), and the average value reported in both ounces/inch and Newtons/decimeter. The failure mode was also noted as follows. “Adh” indicated adhesive failure where the tape removed cleanly without leaving any residue on the glass plate. “Coh” indicated cohesive failure (a splitting of the adhesive) with residue left on both the glass plate and tape backing.

### Shear Strength—Room Temperature (23° C.)

Shear strength at 23° C. and 50% relative humidity (RH) was measured according to ASTM D3654/D 3654M-06: “Standard Test Methods for Shear Adhesion of Pressure Sensitive Tapes” (Reapproved 2011). After conditioning for 24 hours at 23° C. (73° F.) and 50% relative humidity, tape samples measuring 12.7 millimeters (0.50 inches) wide and 15.2 centimeters (6 inches) long were cut. The tape samples were then applied to a stainless steel panel previously wiped clean with methyl ethyl ketone (MEK), then n-heptane, and again with MEK. The samples were then centered on the panels and adhered to one end such that tape overlapped the panel by 25.4 millimeters (1 inch) in the lengthwise direction. The tape sample was then rolled down twice in each direction using a 2 kilogram (4.4 pounds) rubber roller.

A 1.0 kilogram (2.2 pounds) weight was then attached to the free end of the tape, and the panel/tape/weight assembly was suspended in a stand. The time, in minutes, for the tape to fall from the panel was recorded along with the mode of failure. Two different failure modes were observed: 1) cohesive (c) in which the adhesive split and part was left on the stainless steel plate and part left on the tape backing; and 2) pop-off (p) in which the adhesive tape was cleanly delaminated from the panel. The test was terminated if failure had not occurred in 10,000 minutes and the result recorded as “10,000+”. The average of two samples was reported.

### Shear Strength—Elevated Temperature (70° C.)

### Procedure A

Shear strength was evaluated in the same manner as described for room temperature testing with the following modifications. A weight of 0.5 kilograms (1.1 pounds) was used and the panel/tape/weight assembly was place in an oven set at 70° C. (158° F.).

### Procedure B

Procedure A was repeated with the following modification. A weight of 1.0 kilograms (2.2 pounds) was used.

### Preparation of PPO-Urethane Acrylate (PPO-U-A) Macromer

To a 250 milliliter, two port, round bottom flask equipped with a condenser, were added the following materials: 37.4 grams SA120, 2 grams 2-isocyanatoethylacrylate, 175 grams toluene, and a drop of dibutyl tin laurate. This was mixed using a magnetic stir bar at 80° C. for 4 hours then allowed to cool with stirring to room temperature to provide a 15.8 wt % solids solution of PPO-U-A macromer.

### Preparation of PPO-U-A Macromer Grafted Acrylic Polymer

To a transparent glass jar were added the following materials: 60 grams IOA, 2.6 grams AA, 0.03 grams 1651, 78 grams ethyl acetate, 20 grams toluene, and 16.8 grams of 15.8% solids solution of PPO-U-A macromer (prepared as described above). This was mixed at room temperature using a magnetic stir bar. Stirring was then discontinued and the mixture was deaerated by bubbling nitrogen gas through it for 10 minutes. Next, the jar was tightly capped, placed on a rubber roller, and exposed to UV black light (254 nanometer wavelength) for five hours after which the jar was opened to terminate the polymerization reaction. The resulting solution of PPO-U-A macromer grafted IOA:AA acrylic polymer (IOA:AA:PPO-U-A/92:4:4 (w:w:w)), having a solids content of 15.2 wt % was used to prepare pressure sensitive adhesive tapes as described in the examples below. Analysis of the polymer solution using gel permeation chromatography and a UV detection system indicated 56% of the PPO-U-A macromer was grafted onto the acrylic polymer.

### Comparative Example 1

Comparative Example 1 was prepared to demonstrate the improvement in adhesive properties provided by Examples 1-6. A copolymer of IOA/AA grafted with polystyrene (PS) was prepared according to Example 11 of U.S. Pat. No. 5,057,366 with the following modifications. The weight ratio of the IOA/AA/polystyrene (C2) monomers used was 92/4/4 and the inherent viscosity (I.V.) of the resulting polymer was 0.65 deciliters/gram.

### Examples 1-6

The PPO-U-A macromer grafted IOA:AA acrylic polymer solution prepared as described above was combined with various amounts of FORAL 85E (15.2 wt % solids solution in ethyl acetate) as shown in Table 1 below. The amounts of grafted polymer and tackifier listed in Table 1 are given on a dry basis weight ratio. The resulting solutions were coated onto PET Film using a knife coater having a gap setting of 0.51 millimeters (0.020 inches and dried at 70° C. for 20 minutes to give pressure sensitive adhesive tapes having an adhesive thickness of between 46 and 50 micrometers (0.0018 and 0.002 inches). These tapes were then evaluated for peel adhesion and shear strengths as described in the test methods above, and the results reported in Table 1 below.

### Preparation of PPO-Urethane Methacrylate (PPO-U-MA) Macromer

To 175 milliliters toluene was added and dissolved 40 grams of SA120; this was then heated to 70° C. Next, 3.0 grams 2-isocyanatoethylmethacrylate (IEMA) was slowly added followed by stirring for another 16 hours. The solution was allowed to cool to room temperature, then poured into 750 milliliters of hexanes to precipitate the PPO-U-MA macromer. The precipitate was filtered, washed with hexanes, and dried to give 27 grams of solid PPO-U-MA macromer.

### Preparation of PPO-U-MA Macromer Grafted Acrylic Polymer

To an amber colored glass bottle were added the following materials: 44 grams of a 4.9 wt % solids solution of PPO-U-MA macromer in toluene, 50 grams IOA, 2.17 grams AA, 0.027 grams VAZO 67, and 82 grams ethyl acetate. The mixture was deaerated by bubbling nitrogen gas through it for 10 minutes. Next, the jar was tightly capped, placed on a shaker at room temperature for approximately 30 minutes then in a laundrometer for 24 hours at 60° C. The bottle was then opened to terminate the polymerization reaction. The resulting solution of PPO-U-MA macromer grafted IOA:AA acrylic polymer (IOA:AA:PPO-U-MA/92:4:4 (w:w:w)), having a solids content of approximately 30 wt % was used to prepare pressure sensitive adhesive tapes as described in the example below.

### Example 7

Example 1 was repeated with the following modification. PPO-U-MA macromer grafted IOA:AA acrylic polymer, prepared as described above, was used in place of PPO-U-A macromer grafted IOA:AA acrylic polymer. The resulting dried adhesive thickness was about 38 micrometers (0.0015 inches). This tape was then evaluated for peel adhesion and shear strengths as described in the test methods above, and the results reported in Table 1 below.

TABLE 1
Compositions and Results

| | | | | | | | Shear | Shear | Shear |
|---|---|---|---|---|---|---|---|---|---|
| | | | | | | | strength | strength | strength |
| | PPO | | | | | | (23° C.) | (70° C.) | (70° C.) |
| | containing | | Foral | Peel adhesion strength | | | 1000 | 500 grams | 1000 gram |
| | macromer | Macromer | 85E | | | Failure | grams | Procedure | Procedure |
| Ex | (pbw) | type | (pbw) | oz/in | N/dm | mode | (min) | A (min) | B (min) |
| CE1 | 100 | — | 0 | 59 | 65 | adh | 3,970 | 19 | 3 |
| 1 | 100 | acrylate | 0 | 53 | 58 | adh | 10,000+ | 10,000+ | 10,000+ |
| 2 | 100 | acrylate | 10 | 56 | 62 | adh | 10,000+ | ND | 182 |
| 3 | 100 | acrylate | 20 | 58 | 64 | adh | 10,000+ | ND | 33 |
| 4 | 100 | acrylate | 30 | 66 | 73 | adh | 10,000+ | ND | 16 |
| 5 | 100 | acrylate | 50 | 79 | 87 | adh | 2,275 | ND | ND |
| 6 | 100 | acrylate | 100 | 120 | 132 | coh | 546 | ND | ND |
| 7 | 100 | methacrylate | 0 | 42 | 46 | adh | 10,000+ | 10,000+ | 10,000+ |

ND: not done
Shear test failure modes were all cohesive

1-19. (canceled)

20. A pressure sensitive adhesive composition comprising a poly(phenyleneoxide)-grafted (meth)acrylate copolymer.
wherein the copolymer is of the formula:
˜[M^{Ester}]ₐ-[M^{PPO}]_{b}-[M^{acid}]_{c}-[M^{polar}]_{d}˜, wherein
[M^{Ester}] represents (meth)acrylate ester monomer units wherein subscript a is 80-99.9 parts by weight;
[M^{PPO}] represents poly(phenyleneoxide) functional monomer units wherein subscript b is 0.1-10 parts by weight;
[M^{acid}] represents acid functional monomer units wherein subscript c is 0-15 parts by weight;
[M^{polar}] represents non-acid-functional polar monomer units wherein subscript d is 0 to 10 parts by weight;
wherein the sum of a to d is 100 parts by weight.

21. The composition of claim 20 wherein subscript a is 80 to 95 parts by weight.

22. The composition of claim 20 wherein the (meth)acrylate ester monomer include high T_{g} (meth)acrylate ester monomers in amounts of up to 30 parts by weight of the 80 to 99.5 parts by weight of (meth)acrylate ester monomer component, said high T_{g} monomers having a T_{g} of at least 25° C.

23. The composition of claim 20 wherein subscript b is 0.1-5 parts by weight.

24. The composition of claim 20 wherein subscript c is 0.5 to 5 parts by weight.

25. The composition of claim 20 wherein subscript d is 0.5 to 5 parts by weight.

26. The composition of claim 20 wherein the poly(phenyleneoxide)functional monomers are of the formula: 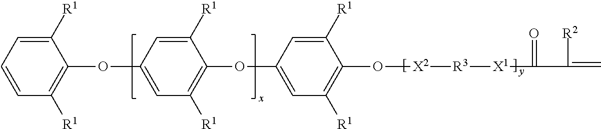
wherein
R¹ is H, a monovalent hydrocarbyl group, including an aryl group and an alkyl group;
R² is H or C₁-C₄ alkyl,
R³ is a divalent alkylene;
X¹ is —O— or —NR⁴—, where R⁴ is H or C₁-C₄ alkyl;
X² is —CO—NH—, —CO—, CH₂—CH(OH)—CH₂—, or a covalent bond;
subscript x is at least one, preferably 10-100, more preferably 20-60; and
subscript y is 0 or 1.

27. The composition of claim 20 further comprising a tackifier in amounts of 1 to 80 wt. %, based on the total weight percent of the adhesive composition.

28. The composition of claim 20 containing no chemical crosslinking agent.

29. An adhesive article comprising a layer of the adhesive composition of claim 20 on a substrate.

30. A method of preparing the adhesive copolymer of claim 20 by free-radical polymerization of acrylate ester monomer units, poly(phenyleneoxide)-functional (meth)acryloyl monomer units, optional acid-functional monomer units, and optional non-acid functional polar monomer units, in the presence of an initiator.

31. The method of claim 30 wherein the initiator is a thermal initiator.

32. The method of claim 30 wherein the initiator is a photoinitiator.

33. The method of claim 30 wherein the step of polymerization is in the presence of a chain transfer agent.

34. A method for preparing the adhesive copolymer of claim 20 by functionalizing a copolymer of the formula:
˜[M^{Ester}]ₐ-[M^{FG}]_{b*}-[M^{acid}]_{c}-[M^{polar}]_{d}˜,
wherein
[M^{Ester}] represents (meth)acrylate monomer units of subscript a parts by weight;
[M^{FG}] represents hydroxyl-reactive functional monomer units of subscript b* parts by weight;
[M^{acid}] represents acid functional monomer units of subscript c parts by weight;
[M^{polar}] represents non-acid-functional polar monomer units of subscript d parts by weight;
with a poly(phenylene oxide) oligomer.

35. The method of claim 34 wherein the PPO oligomer has a M_{w} from 4,000 to 8,000 Da.
